(19) United States
(12) Patent Application Publication
(10) Pub. No.: US 2015/0068456 A1
(43) Pub. Date: Mar. 12, 2015

(54) MASK ADJUSTMENT UNIT, MASK DEVICE, AND APPARATUS AND METHOD FOR PRODUCING MASK

(71) Applicant: Sony Corporation, Tokyo (JP)

(72) Inventors: Kentaro Kuriyama, Kanagawa (JP); Tomohiro Kubo, Kanagawa (JP)

(73) Assignee: Sony Corporation, Tokyo (JP)

(21) Appl. No.: 14/388,568

(22) PCT Filed: Jan. 31, 2013
(86) PCT No.: PCT/JP2013/000532

§ 371 Date: Sep. 26, 2014

(30) Foreign Application Priority Data
Apr. 5, 2012 (JP) 2012-086186

(51) Int. Cl. B05B 15/04; B23Q 1/03

(52) U.S. Cl. CPC B05B 15/0481; B05B 15/0456; B23Q 1/03
USPC 118/505; 269/289 R; 29/559

(57) ABSTRACT

[Object] To provide techniques such as a mask adjustment unit capable of appropriately adjusting the position of a mask pattern.

[Solving Means] A mask adjustment unit according to the present technology includes a base body, a movable member, and an adjustment mechanism. The movable member supports a side of an outer edge portion of a mask main body and is movably provided on the base body, the mask main body having the outer edge portion. The adjustment mechanism applies, to the mask body via the movable member, both pulling tension force from the outer edge portion of the mask main body to outside of the mask main body and pressing force pressing from the outer edge portion to inside of the mask main body, the mask body being supported by the movable member.

### TECHNICAL FIELD

The present technology relates to a mask adjustment unit, a mask device on which the mask adjustment unit is mounted, and an apparatus and a method for producing the mask device that adjust stress applied to a mask used for deposition or the like.

### BACKGROUND ART

From the past, in a process of producing a display apparatus using an organic EL (Electro-Luminescence) device, for example, a pattern of a material film is formed on each pixel of red, green, and blue (RGB) of a substrate by vacuum deposition using a mask for deposition.

Such a mask for deposition is produced in the following way. First, a mask foil in which many fine opening patterns are provided is prepared by electro-casting, a photoetching method, or the like. Next, in a state where tension force is applied to this mask, the mask is fixed to a supporting frame by welding or the like. If the mask is fixed as described above, it has been difficult to adjust the tension force of the mask after the fixation.

In general, a mask has different stress distribution depending on the coarse density of forming density of the opening pattern or non-uniform distribution of the film thickness caused during electro-casting or rolling. Furthermore, because there is an individual difference in the deformation amount of a supporting frame of the mask itself, it is very difficult to predict modification in advance by deformation analysis or the like. In view of the above, a method of correcting the position of the opening pattern after the mask is fixed to the frame is proposed in Patent Document 1.

The mask for deposition described in Patent Document 1 includes a mask main body held by a mask frame, a guide member attached to at least one side of the mask main body, and a tension force applying means for applying predetermined tension force to the mask main body via the guide member. The tension force applying means includes a screw hole formed on a side wall of the guide member and a screw whose tip portion is brought into contact with a side surface of the mask frame, which can be inserted into the screw hole. An operator can apply tension force to the mask main body by tightening or loosening the screw (see, for example, paragraphs [0031] to [0035] of the specification and FIG. 4 of Patent Document 1).

### CITATION LIST

### Patent Document

Patent Document 1: Japanese Patent Application Laid-open No. 2004-6257

### DISCLOSURE OF THE INVENTION

### Problem to be Solved by the Invention

However, the structure of the tension force applying means described in Patent Document 1 is a structure in which the tension force is increased as the degree of tightening is increased. Specifically, because it is only a structure in which tension force is applied to the mask main body, it is difficult to appropriately adjust the position of the mask pattern formed on the mask.

It is an object of the present invention to provide techniques such as a mask adjustment unit capable of appropriately adjusting the position of the mask pattern.

### Means for Solving the Problem

In order to achieve the above-mentioned object, a mask adjustment unit according to the present technology includes a base body, a movable member, and an adjustment mechanism.

The movable member supports a side of an outer edge portion of a mask main body and is movably provided on the base body, the mask main body having the outer edge portion.

The adjustment mechanism applies, to the mask body via the movable member, both pulling tension force from the outer edge portion of the mask main body to outside of the mask main body and pressing force pressing from the outer edge portion to inside of the mask main body, the mask body being supported by the movable member.

Because the adjustment mechanism can apply both tension force and pressing force to the mask main body, it is possible to fine adjust the position of the mask pattern provided on the mask main body, appropriately.

The adjustment mechanism may include at least one bolt that acts on the movable member. The bolt may act on the movable member directly or indirectly.

The adjustment mechanism may include a first bolt that applies the tension force to the mask main body, and a second bolt that applies the pressing force to the mask main body.

The adjustment mechanism may have a supporting portion that supports the first bolt and the second bolt, the supporting portion being provided on the base body. Moreover, the movable member may have a screw hole into which the first bolt is inserted and a contact area with which an end portion of the second bolt is brought into contact.

With the two first and second bolts, it is possible to generate tension force and pressing force.

The adjustment mechanism may further include a conversion member that is connected to at least one of the first bolt and the second bolt. The conversion member converts power of the at least one bolt in a first moving direction into power in a second moving direction, and transmits the converted power to the movable member, the second moving direction being different from the first moving direction.

As described above, the transmitting member may convert power in a moving direction of a bolt into power in a direction different from that, and move the movable member.

The adjustment mechanism may further include a fixed body and a transmitting member. The fixed body is provided on the base body. The transmitting member may be connected to the base body with any one of the first bolt and the second bolt between the fixed body and the movable member, convert power of any one of the first bolt and the second bolt in a first moving direction into power in a second moving direction, and transmit the converted power to the movable member, the second moving direction being different from the first moving direction.

The transmitting member may be an elastic body that acts on the movable member by an elastic deformation. Because an elastic deformation of an elastic body is used, it is possible to fine adjust the position of a mask pattern with high accuracy.

The movable member may have a tapered surface. The fixed body may have a tapered surface facing the tapered surface of the movable member and may be provided on the base body so that interval between the tapered surface of the movable member and the tapered surface of the fixed body changes toward a vertical direction of a pattern surface on which a mask pattern is formed, the mask main body having the pattern surface. The transmitting member may be a block member arranged between the tapered surface of the movable member and the tapered surface of the fixed body so that the block member is brought into contact with the tapered surfaces.

The adjustment mechanism may further have a supporting portion provided on the base body, which supports the bolt, and a regulation portion that regulates movement of the bolt along an inserting and removing direction of the bolt with respect to the supporting portion. Accordingly, the adjustment mechanism can generate both tension force and pressing force with one bolt for adjustment.

The adjustment mechanism may include a first cam member that applies the tension force to the mask main body, and a second cam member that applies the pressing force to the mask main body. Accordingly, the adjustment mechanism can generate both tension force and pressing force without a bolt for adjustment.

The adjustment mechanism may include a piezoelectric element capable of applying the tension force and the pressing force to the mask main body.

The mask adjustment unit may further include an adjustment frame and an adjustment member.

The adjustment frame is connected to the base body so that the adjustment frame faces the base body in a direction vertical to a pattern surface on which a mask pattern is formed and a gap is formed between the adjustment frame and the base body, the mask main body having the pattern surface.

The adjustment member adjusts a distance of the gap in the vertical direction. Accordingly, because a gap is formed between the adjustment frame and the base body and the distance of the gap is adjusted by the adjustment member, it is possible to correct the deflection of the mask main body or to pull-up the mask main body in a direction opposite to a gravity direction.

A mask device according to the present technology includes a mask main body and the above-mentioned mask adjustment unit that supports the mask main body.

A mask producing apparatus according to the present technology is a mask producing apparatus for producing a mask device by adjusting a position of a mask pattern of a mask main body having an outer edge portion, a pattern surface, and the mask pattern formed on the pattern surface.

The mask producing apparatus includes a detection unit, an operating device, and a controller.

The detection unit detects actual location information being location information on the mask pattern in the pattern surface in a state where the mask main body of the mask device is supported by a movable member.

The operating device drives the adjustment mechanism of the mask device.

The controller acquires designing location information being location information of the mask pattern out of designing information of the mask main body, and calculates an amount of displacement of the actual location information from the designing location information based on the acquired designing location information and the detected actual location information. Then, the controller controls the operating device based on the calculated displacement amount.

Accordingly, it is possible to automatically adjust the position of a mask pattern of a mask main body, appropriately. Therefore, it is possible to increase the productivity of a device to be produced by the mask device.

The operating device may include a motor and a reducer that reduces drive of the motor. Accordingly, it is possible to fine adjust the position of a mask pattern with high accuracy.

The mask producing apparatus may further include a guide mechanism that allows the operating device to move along the mask main body. Accordingly, it is possible to change the position at which stress is applied by an operating device via an adjustment mechanism.

A mask producing method according to the present technology is a mask producing method for producing a mask device by adjusting a position of a mask pattern of a mask main body having an outer edge portion, a pattern surface, and the mask pattern formed on the pattern surface.

Actual location information being location information of the mask pattern in the pattern surface is detected in a state where the mask main body of the mask device is supported by a movable member.

Designing location information being location information of the mask pattern out of designing information of the mask main body is acquired.

An amount of displacement of the actual location information from the designing location information is calculated based on the acquired designing location information and the detected actual location information.

An operating device that drives the adjustment mechanism of the mask is controlled based on the calculated displacement amount.

### Effect of the Invention

According to the present technology, it is possible to appropriately adjust the position of a mask pattern.

### BRIEF DESCRIPTION OF DRAWINGS

FIG. 1 is a perspective view showing a mask including a mask adjustment unit according to a first embodiment of the present technology.

FIG. 2 is a plan view of the mask adjustment unit shown in FIG. 1.

FIG. 3 is an enlarged view showing an example of a mask pattern.

FIG. 4 is a schematic diagram of a cross-section taken along the line C-C in FIG. 2.

FIG. 5 is a diagram showing an enlarged site surrounded by an alternate long and short dash line E (a part of the adjustment mechanism) in FIG. 2.

FIG. 6A is a cross-sectional view taken along the line A-A in FIG. 5, and FIG. 6B is a cross-sectional view taken along the line B-B in FIG. 5.

FIG. 7 is a cross-sectional view taken along the line D-D in FIG. 2.

FIG. 8 is a diagram showing deflection of a base frame.

FIGS. 9A to C are each a cross-sectional view showing an example of a position holding mechanism.

FIG. 10 is a cross-sectional view showing an example of the position holding mechanism.

FIG. 11 shows the position holding mechanism that holds the position of a mask main body after the position is adjusted by the adjustment mechanism shown in FIG. 10.

FIG. 12 is a cross-sectional view of an adjustment mechanism of a mask adjustment unit according to a third embodiment of the present technology viewed in the Z-axis direction.

FIG. 13A is a plan view an adjustment mechanism of a mask adjustment unit according to a fourth embodiment of the present technology. FIG. 13B is a cross-sectional view taken along the line E-E in FIG. 13A.

FIG. 14 is a plan view showing an adjustment mechanism of a mask adjustment unit according to a fifth embodiment of the present technology.

FIG. 15A is a cross-sectional view taken along the line F-F in FIG. 14. FIG. 15B is a cross-sectional view taken along the line G-G in FIG. 14.

FIG. 16 is a cross-sectional view of an adjustment mechanism of a mask adjustment unit according to a sixth embodiment of the present technology viewed in the Z-axis direction.

FIG. 17 is a cross-sectional view of an adjustment mechanism of a mask adjustment unit according to a seventh embodiment of the present technology viewed in the Y-axis direction.

FIG. 18A is a plan view showing an adjustment mechanism of a mask adjustment unit according to an eighth embodiment of the present technology. FIG. 18B is a cross-sectional view taken along the line H-H in FIG. 18A.

FIG. 19A is a plan view showing an adjustment mechanism of a mask adjustment unit according to a ninth embodiment of the present technology. FIG. 19B is a cross-sectional view taken along the line I-I in FIG. 19A.

FIG. 20 is a diagram showing a mask producing apparatus.

FIG. 21 is a perspective view showing one operating device.

FIG. 22 is a perspective view showing a state where a mask device is set on a mask producing apparatus.

FIG. 23 is a perspective view showing a mask producing apparatus according to another example.

### MODE(S) FOR CARRYING OUT THE INVENTION

Hereinafter, embodiments according to the present technology will be described with reference to the drawings.

### First Embodiment

### Mask Adjustment Unit and Mask Device

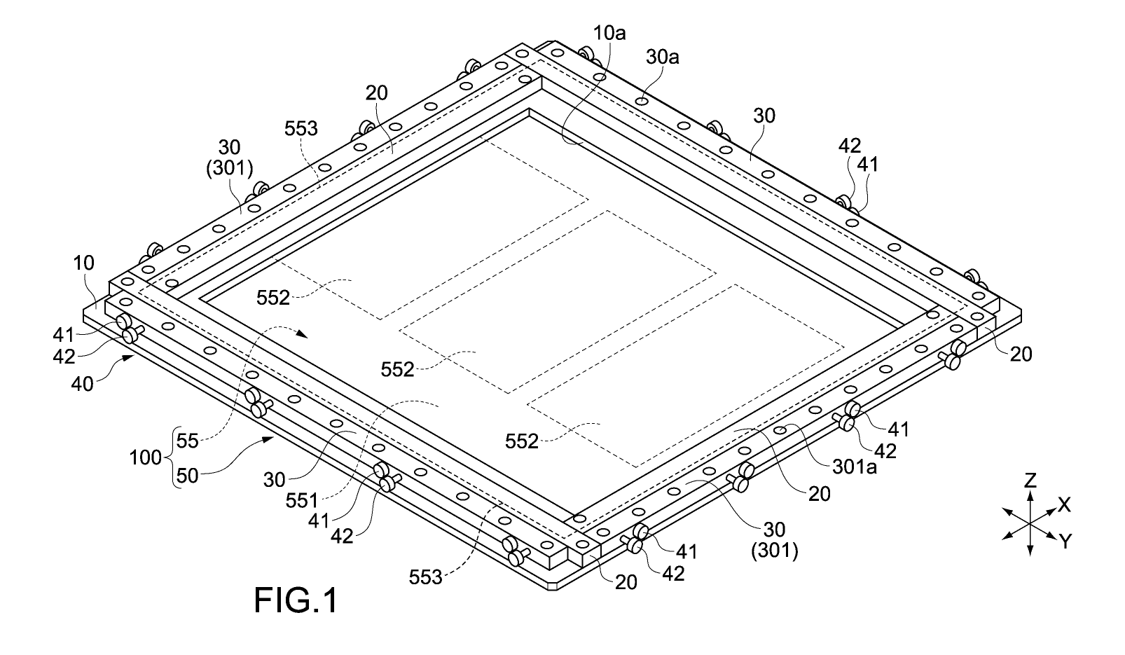

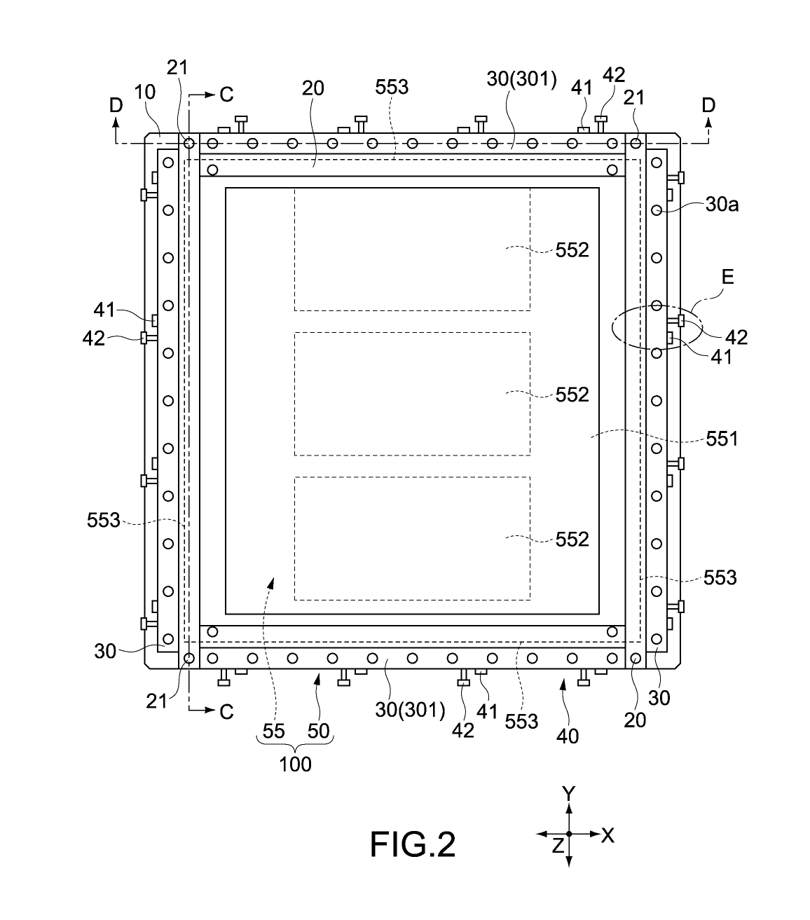

FIG. 1 is a perspective view showing a mask device including a mask adjustment unit according to a first embodiment of the present technology. FIG. 2 is a plan view thereof.

A mask device 100 includes a mask main body 55 formed as mask foil and a mask adjustment unit 50 that supports the mask main body 55. The mask device 100 typically can be used as a mask for deposition in a process of producing a display device using an organic EL device.

The mask main body 55 includes mainly a metal material such as nickel (Ni), inver (Fe/Ni alloy), and copper (Cu). The thickness of the mask main body 55 is typically about 10 to 50 μm. The mask main body 55 has a pattern surface 551 on which a mask pattern is formed. For example, on the mask main body 55, three pattern areas 552 are formed so that three display surfaces can be formed. In the respective pattern areas 552, the same mask pattern is formed, for example.

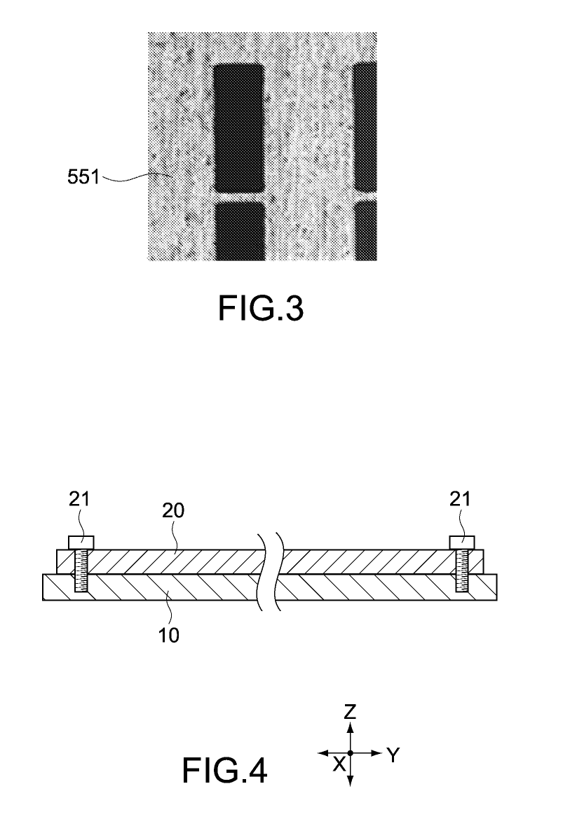

The mask pattern is, for example, a plurality of passing holes (through-holes) arranged in a matrix pattern or a staggered pattern, and one passing hole is an element for forming one pixel area in a display device. For example, the passing hole has a slit, slot, or circle shape. Via the passing hole, a low-molecule organic EL material is deposited on a substrate that is not shown. In the case of three colors of RGB, three mask devices are used depending on the number of colors. Examples of the passing hole of the mask main body 55 include a passing hole shown in FIG. 3 (black part).

In a state where tension force is applied to the mask main body 55 to some extent, the mask main body 55 is fixed to the mask adjustment unit 50 by spot welding (by, for example, electrical resistance or a laser) and is supported.

The mask adjustment unit 50 includes a rectangular base frame (base body) 10 having an opening 10a. In addition, the mask adjustment unit 50 includes four movable members 20 provided corresponding to four sides of the base frame 10. Each of the movable members 20 has a long shape along the X and Y axis.

The size of the outer shape of a rectangular portion formed by the four movable members 20 is almost the same as or a little larger than the size of the outer shape of the mask main body 55. On the upper surface of the movable members 20, an outer edge portion 553 of the mask main body 55 is fixed by welding. The mask main body 55 is fixed to the movable member 20 so that three pattern areas 552 of the mask main body 55 are housed in the opening 10a of the base frame 10 when viewed in the Z-axis direction. The Z-axis direction is a direction vertical to the pattern surface 551 of the mask main body 55, on which a mask pattern is formed.

Each of the movable members 20 has almost the same structure. For example, a screw hole is formed on the upper surface of both end portions of one movable member 20, and the movable member 20 is connected to the base frame 10 by a screw that is not shown. Therefore, areas other than the end portions of the movable member 20 are movable to be deformed along the X-axis direction (or the Y-axis direction) as will be described later.

The mask adjustment unit 50 includes an adjustment mechanism 40 that applies stress to the mask main body 55 via the above-mentioned movable member 20. The adjustment mechanism 40 includes a pulling bolt (first bolt) 41 that applies tension force (pulling force) to the mask main body 55 and a pressing bolt (second bolt) 42 that applies pressing force to the mask main body 55. In addition, the adjustment mechanism 40 includes a supporting member (supporting portion) 30 that supports the pulling bolt 41 and the pressing bolt 42.

Four supporting members 30 are provided corresponding to four sides of the base frame 10, for example, and each of which has a long shape. These supporting members 30 have almost the same structures. These supporting members 30 are arranged outside of the movable member 20 on the base frame 10. The supporting member 30 has many screw holes 30a along the longitudinal direction thereof, and each supporting member 30 is fixed to the base frame 10 by a screw that is not shown.

It should be noted that the supporting member 30 may be formed by casting with the material of the base frame 10.

The pulling bolt 41 and the pressing bolt 42 are arranged adjacent to each other. With the pulling bolt 41 and the pressing bolt 42 as a set of bolts, a plurality of sets of bolts are arranged at a predetermined pitch in the X- and Y-axis directions. The distance between the pulling bolt 41 and the pressing bolt 42 can be appropriately set. Moreover, the pitch for each set of bolts (41 and 42) can be appropriately set similarly.

In the mask adjustment unit 50, typically, the material of the base frame 10, the supporting member 30, the movable member 20, and the like includes a material having the thermal expansion coefficient of the material of a substrate to be a processing target (substrate on which an organic material is deposited). This aims to expand/contract the mask device 100 and the substrate in synchronization with each other and make the change amount of the size due to the expansion and contraction equivalent with a temperature change during a deposition process. Moreover, it is favorable that the base frame 10 has a sufficient thickness and a high rigidity to make the deformation amount as little as possible and the weight of the base frame 10 is reduced to a realistic weight taking into account transporting or handling.

Moreover, by at least using a relatively soft material, i.e., a material having a low Young's modulus, as the material of the movable member 20, it is possible to perform fine adjustment with high accuracy. By making a cut in the movable member 20, for example, it is possible to enlarge the movable range further.

FIG. 4 is a schematic diagram of a cross-section taken along the line C-C in FIG. 2. Fixing bolts 21 are attached to both end portions of the movable member 20 and the base frame 10. With these fixing bolts 21, the end portions of the movable member 20 are fixed to the base frame 10. Areas other than the end portions of the movable member 20 are movable in the horizontal direction (X- or Y-axis direction) by deformation with respect to the base frame 10.

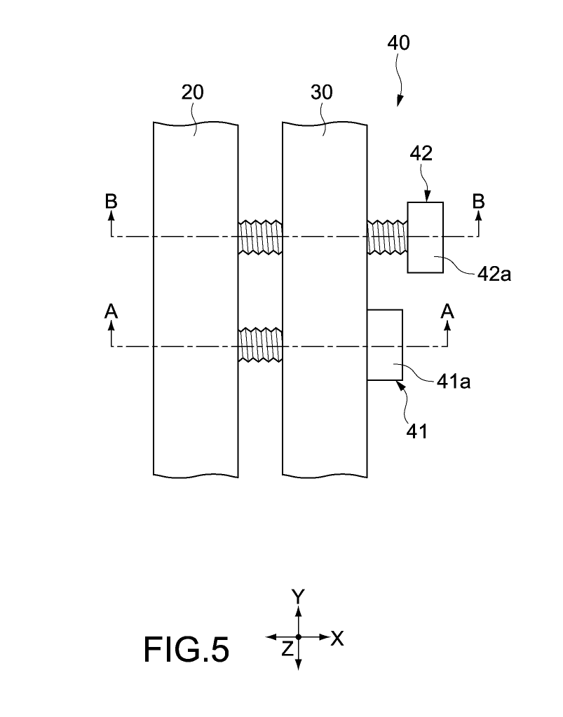

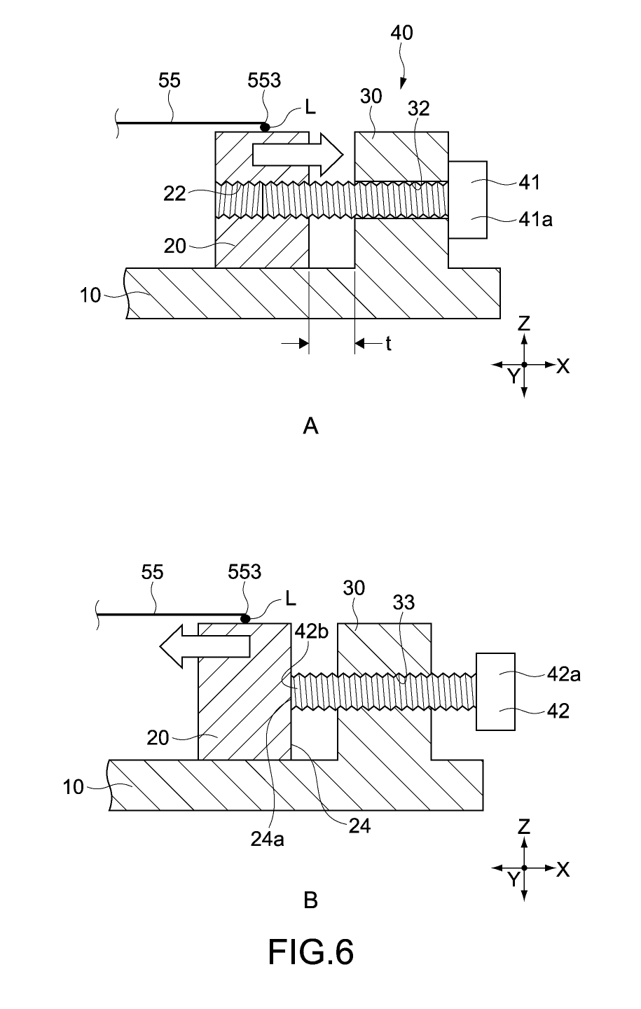

FIG. 5 is a diagram showing an enlarged site surrounded by an alternate long and short dash line E (a part of the adjustment mechanism 40) in FIG. 2. FIG. 6A is a cross-sectional view taken along the line A-A in FIG. 5, and FIG. 6B is a cross-sectional view taken along the line B-B in FIG. 5.

As shown in FIGs. 6A and B, the mask main body 55 is bonded to the movable member 20 by welding (shown by a welding point L). As the pulling bolt 41 and the pressing bolt 42, the same bolt is used basically. For example, a bolt having a size from M2 (diameter of 2 mm) to M5 (diameter of 5 mm) is used. However, it is not limited thereto.

The range in the X-axis direction (and the y-axis direction) in which the plurality of sets of bolts (41 and 42) are arranged can be set appropriately.

As shown in FIG. 6A, a distance t between the supporting member 30 and the movable member 20 can be appropriately set taking into account the range to be adjusted by the adjustment mechanism 40. For example, in the case of a mask having a side length of about 600 mm, it is possible to make the distance t between them about 100 μm. The distance t only needs to be a distance sufficiently longer than the distance for adjusting the position of a passing hole formed as a mask pattern.

As shown in FIG. 6A, the pulling bolt 41 includes a head 41a. A screw hole along the X-axis direction is provided on the movable member 20, and a through hole 32 is provided on the supporting member 30 in the X-axis direction. No thread is provided in the through hole 32. The pulling bolt 41 is supported by the through hole 32, and is inserted into the screw hole 22 of the movable member 20. By tightening the pulling bolt 41 in a state where the head 41a of the pulling bolt 41 is brought into contact with the supporting member 30, power of the pulling bolt 41 acts on the movable member 20 and the movable member 20 moves in the direction toward the supporting member 30.

Accordingly, pulling tension force from the outer edge portion 553 to outside of the mask main body 55 is generated on the mask main body 55. As a result, the position of the passing hole formed on the mask main body 55 is adjusted to move toward outside of the mask main body 55.

As shown in FIG. 6B, the pressing bolt 42 includes a head 42a. A screw hole 33 along the X-axis direction is provided on the supporting member 30, and the pressing bolt 42 is inserted into the screw hole 33 and is supported by the supporting member 30. Then, a tip portion (end portion) 42b of the pressing bolt 42 is brought into contact with a side surface 24 of the movable member 20. Specifically, the movable member 20 has a contact area 24a of the tip portion 42b of the pressing bolt 42.

By tightening the pressing bolt 42 in a state where the tip portion of the pressing bolt 42 is brought into contact with the side surface 24 of the movable member 20, power of the pressing bolt 42 acts on the movable member 20 and the movable member 20 moves in a direction away from the supporting member 30. Accordingly, pressing force pressing from the outer edge portion 553 to inside (center) of the mask main body 55 is generated on the mask main body 55. As a result, the position of the passing hole formed on the mask main body 55 is adjusted to move toward inside of the mask main body 55.

It should be noted that in FIGS. 6A and B, instead of the head 41a of the pulling bolt 41 and the head 42a of the pressing bolt 42, a nut may be screwed to (a screw portion of) a bolt. In this case, the rotational power of the nut is transmitted to the movable member 20 via the bolt.

Since the adjustment mechanism 40 can apply both tension force and pressing force to the mask main body 55 as described above, it is possible to fine-adjust the position of a mask pattern provided on the mask main body 55, appropriately.

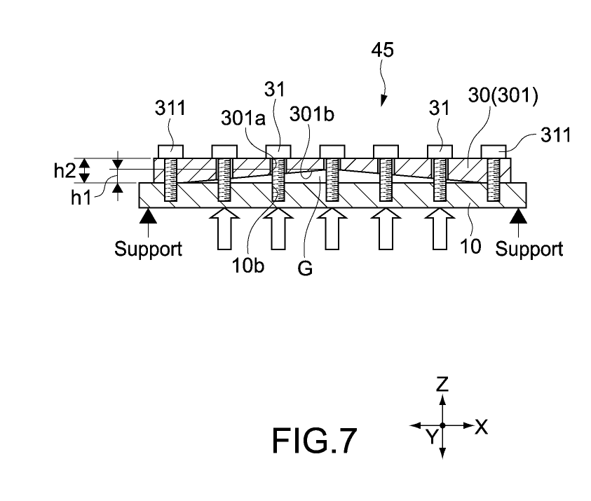

FIG. 7 is a cross-sectional view taken along the line D-D in FIG. 2. The mask adjustment unit 50 includes a Z adjustment mechanism 45 that adjusts the position of the base frame 10 in the Z-axis direction. The Z adjustment mechanism 45 includes two supporting members 301 along the X axis and a plurality of Z adjustment bolts 31 supported by these supporting members 301. In this case, the supporting member 301 functions as an adjustment frame, and the Z adjustment bolt 31 functions as an adjustment member. As the Z adjustment bolt 31, a bolt having a size from M2 to M5 is used. However, it is not limited thereto.

For example, a through hole 301a that passes through the supporting member 301 in the Z-axis direction is provided on the supporting member 301. Screw holes 10b are provided at positions corresponding to the through holes 301a of the base frame 10. Via the through hole 301a of the supporting member 301, the Z adjustment bolt 31 is inserted into the screw hole 10b. Moreover, fixing bolts 311 are attached to both end portions of the supporting member 301. The fixing bolt 311 has a function to fix (both end portions of) the supporting member 301 and the base frame 10 to each other.

Between the supporting member 301 and the base frame 10, a gap G is formed. Specifically, on the lower portion of the supporting member 301, a tapered surface 301b formed so that the size of the gap G is increased from the end portions toward the center is provided. However, it is not limited to the tapered surface, and a concave surface including a curved surface (for example, a circular arc shape) and/or a flat surface only needs to be formed on the lower portion of the supporting member 301.

In the case where a side length of the opening 10a of the base frame 10, which has an almost square shape, is 900 mm, a maximum value h1 of the gap G formed by the tapered surface is about or larger than 2 mm (which is changed depending on the shape and material of the base frame 10). This is because the base frame 10 is considered to be deflected by about 2 mm. The maximum value h1 may be larger than 2 mm because the supporting member 301 itself may be deflected. The maximum value h1 of the gap G can be appropriately set by structural analysis or the like taking into account also a height h2.

In such a Z adjustment mechanism 45, the base frame 10 is lifted in the Z-axis direction by tightening the Z adjustment bolt 31. Accordingly, it is possible to adjust the position of the base frame 10 in the Z-axis direction with the height of the supporting member 301 as a reference. In particular, it is possible to correct the deflection of the base frame 10 in the Z-axis direction. Moreover, by providing the gap G, it is possible to cancel the deflection due to gravity because the gap G lifts the base frame 10 in a direction opposite to a gravity direction. As a result, it is possible to maintain the horizontal state of the base frame 10 and the substrate to be a processing target.

Moreover, because the supporting member 30 that performs pulling adjustment and pressing adjustment functions also as a frame for Z-axis adjustment, it is possible to reduce the size of the mask adjustment unit 50.

As described above, according to the mask device 100 according to this embodiment, because the adjustment mechanism 40 can both tension force and pressing force to the mask main body 55, it is possible to fine adjust the position of a mask pattern provided on the mask main body 55, appropriately.

In general, the aperture ratio and the degree of precision of an organic EL display device have a trade-off relationship with each other. By using the mask device 100 according to this embodiment, the positional accuracy of an opening (passing hole) of a mask for deposition is improved, and it is possible to achieve a display device having a high aperture ratio and a high precision over the limit line of the trade-off. The aperture ratio is increased, i.e., it is possible to achieve an organic El display device having a high brightness and a longer useful life.

Moreover, because the mask device 100 according to this embodiment causes both tension force and pressing force, it is possible to maintain the position (or stress state) of the mask main body 55 after adjustment with the balance between the two stresses. Therefore, there is no need of a separate mechanism for maintaining the position of the mask main body 55 after adjustment.

In this embodiment, by tightening both the pulling bolt 41 and the pressing bolt 42 in the same tightening direction, it is possible to generate tension force and pressing force opposite to the tension force. Therefore, in the case where an operator performs an adjustment manually, the operation can be easily performed.

Moreover, in this embodiment, the Z adjustment mechanism 45 can prevent the base frame 10 from being deflected in the Z-axis direction.

According to this embodiment, it is possible to correct internal residual strain caused during electro-casting in a process of producing a mask or accuracy degradation depending on the degradation of positional accuracy for each process of photoetching.

Moreover, the positional accuracy of a mask pattern has been out of specification in a process of producing a mask in the past. The present technology can overcome this, and contribute to improvement of yield ratio in manufacturing.

Furthermore, even if the position of a mask pattern is displaced through a washing process or the like after the mask device 100 is used for a deposition process, as will be described later, it is possible to correct the displacement according to the present disclosure. Accordingly, it is possible to contribute to prolonging the lifetime of the mask device.

The mask device 100 according to this embodiment is used as a mask for deposition in a deposition apparatus that is not shown. Some deposition apparatuses include a conveyor using a roller transportation method, for example, and a plurality of deposition sources that are not shown are arranged along the Y-axis direction being a transportation direction thereof. A substrate to be a deposition processing target, which is not shown, is mounted on the mask device 100 according to the present technology, and a deposition process is applied to the substrate while two sides of the mask device 100 along the Y-axis direction are supported by a conveyor.

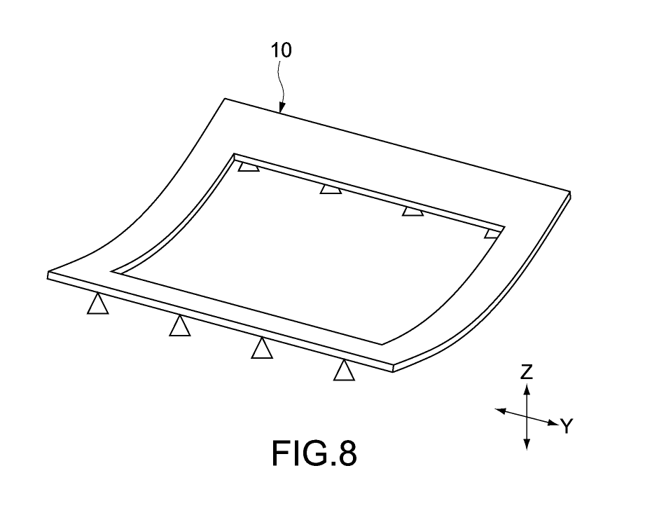

In the case where the mask device 100 according to this embodiment is used as such a deposition apparatus, in recent years in which the mask device 100 is increased in size, the base frame 10 is deflected as shown in FIG. 8 if no countermeasure is taken. This is because the conveyor of the deposition apparatus supports only two sides of the base frame 10 along the Y-axis direction as described above.

As mentioned above, in the case where the base frame 10 has a predetermined large size, the maximum amount of the deflection is about 2 mm. According to the mask device 100 according to this embodiment, the Z adjustment mechanism 45 can truly suppress the deflection of the base frame 10, as described above.

The mask for deposition described in Patent Document 1 cannot suppress such deflection in the Z-axis direction. In addition, as described above, the technique of Patent Document 1 only applies, to the mask main body 55, tension force from the mask main body 55 to outside, and it is difficult to fine adjust a pattern.

Japanese Patent Application Laid-open No. 2006-310183 proposes a method of correcting deflection in a gravity direction by using a metal tape to which tension force is applied. In this case, it is possible to make a frame follow the metal tape. However, it is difficult to perform a fine adjustment of μm order in a gravity direction or to deform the frame in a direction opposite to a gravity direction, unlike the present technology. Moreover, because partial warpage is caused in a frame in some cases due to an influence of warpage or residual stress caused during processing, it is possible to suppress deflection.

Moreover, as an apparatus that corrects warpage in a frame, a tension applying apparatus described in Japanese Patent Application Laid-open No. 2007-257839 is disclosed. In this apparatus, because the position at which a metal tape is attached is limited to a frame rear surface (surface opposite to a mask surface), it is difficult to reproduce the supporting state during actual deposition, and to adjust to the frame warpage state suited to the state during actual deposition.

According to the mask device 100 according to this embodiment, it is possible to solve the above-mentioned problem.

(Position Holding Mechanism that Holds Position after Position Adjustment)

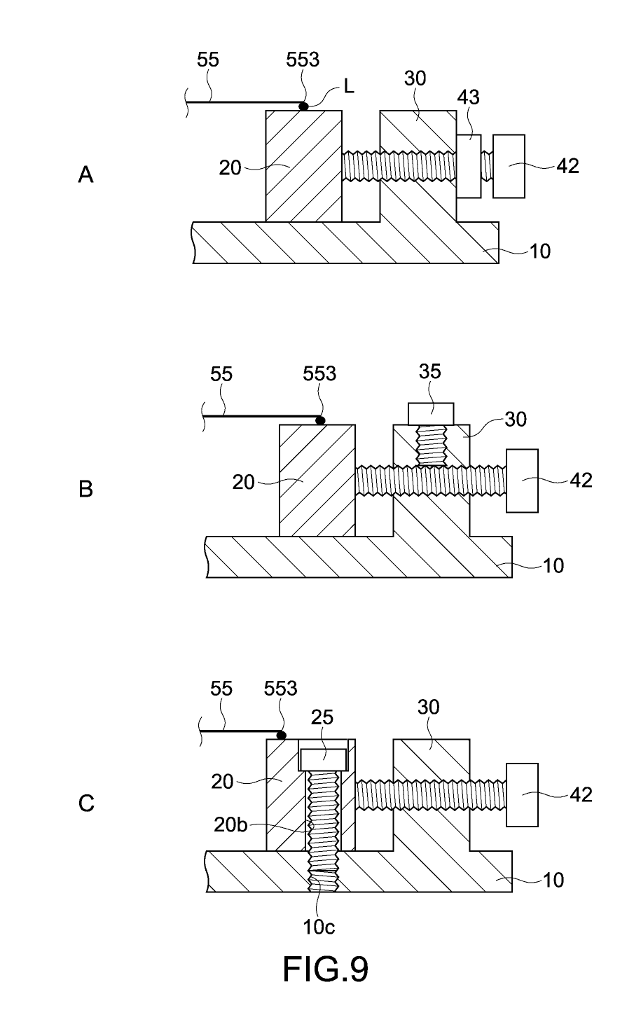

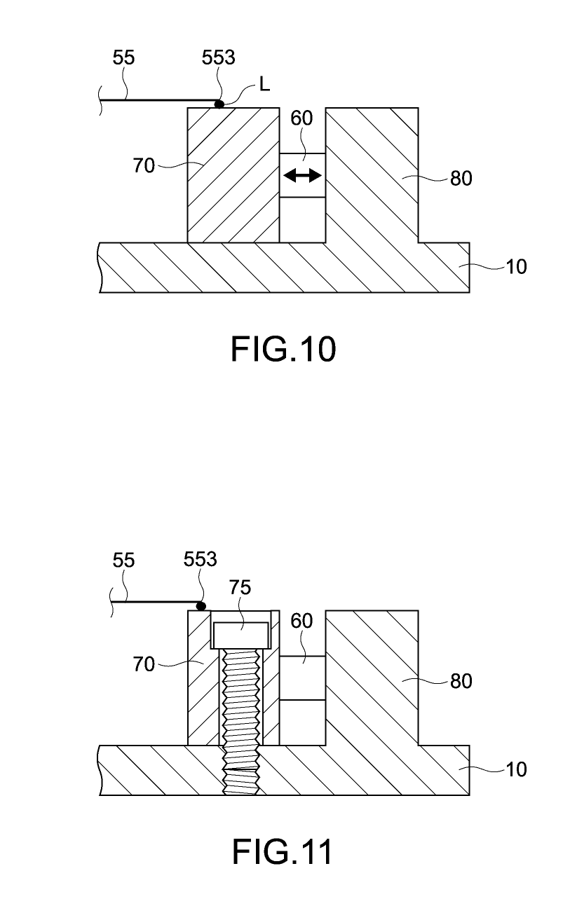

In the above description, there is no need of a mechanism that holds the position of the mask main body 55 after the position of a mask pattern is adjusted by balance of stress due to tension force and pressing force. However, as will be described below, the mask adjustment unit may include a holding mechanism that holds the position of the mask main body 55 after the position of the mask pattern is adjusted. FIGS. 9A to C and FIG. 10 are each a cross-sectional view showing an example of the position holding mechanism.

In the example shown in FIG. 9A, a nut 43 is tightened on the pressing bolt 42, for example. Also on the pulling bolt 41 that is not shown, a nut is tightened similarly.

In the example shown in FIG. 9B, the pressing bolt 42 is fixed from a side of the upper surface of the supporting member 30 with a locking screw 35. Although not shown, the puling bolt 41 is fixed with a locking screw similarly.

In the example shown in FIG. 9C, a fixing bolt 25 is inserted into an insertion hole 20b from a side of the upper surface of the movable member 20, and is attached to a screw hole 10c of a base frame. Thus, the base frame 10 and the movable member 20 are fixed to each other. The size of the insertion hole 20b is such a size that the screw hole 10c is not covered by the movable member 20 even if the movable member 20 moves in the horizontal direction in the figure to adjust the position of a mask pattern.

By providing such a position holding mechanism, it is possible to reliably hold the position of the mask main body 55 after the position of the mask pattern is adjusted.

It should be noted that R processing or step processing may be performed on the edge of the movable member 20 to prevent the movable member 20 from getting stuck with the base frame 10 when the movable member 20 is moved. Processing for reducing friction resistance is performed on at least a portion in which a moving member is in sliding contact with the base frame 10 when the movable member 20 is moved. Therefore, it is possible to easily move the movable member 20.

### Second Embodiment

FIG. 10 is a cross-sectional view showing a part of a mask adjustment unit according to a second embodiment of the present technology, i.e., an adjustment mechanism. In the following description, the members, the functions, and the like similar to those of the adjustment mechanism 40 according to the embodiment shown in FIGS. 6A and B or the like are simplified or omitted, and different points are mainly shown.

The adjustment mechanism according to this embodiment includes a piezoelectric element 60 provided between a supporting member 80 and a movable member 70 provided on the base frame 10. One piezoelectric element 60 can pull and press the movable member 70. Accordingly, tension force and pressing force is applied to the mask main body 55, and the position of the mask pattern is fine adjusted. The adjustment mechanism only needs to include a plurality of piezoelectric elements 60, and the piezoelectric elements 60 are provided in the X-axis direction and also in the Y-axis direction.

Even in the case where the piezoelectric element 60 is used as described above, it is possible to achieve device force equivalent to M2 to M5, for example. Therefore, it is possible to achieve a desired movement distance of the movable member 70.

FIG. 11 shows the position holding mechanism that holds the position of the mask main body 55 after the position is adjusted by the adjustment mechanism shown in FIG. 10. The holding mechanism is the same as the position holding mechanism shown in FIG. 9C, a fixing bolt 75 is attached from a side of the upper surface of the movable member 70, and the movable member 70 is fixed. As shown in FIG. 10, the piezoelectric element 60 returns to the original state after electric power supply to the piezoelectric element 60 is terminated. Therefore, before the termination of electric power supply, it needs to hold the position with a fixing bolt, as shown in FIG. 11, for example.

### Third Embodiment

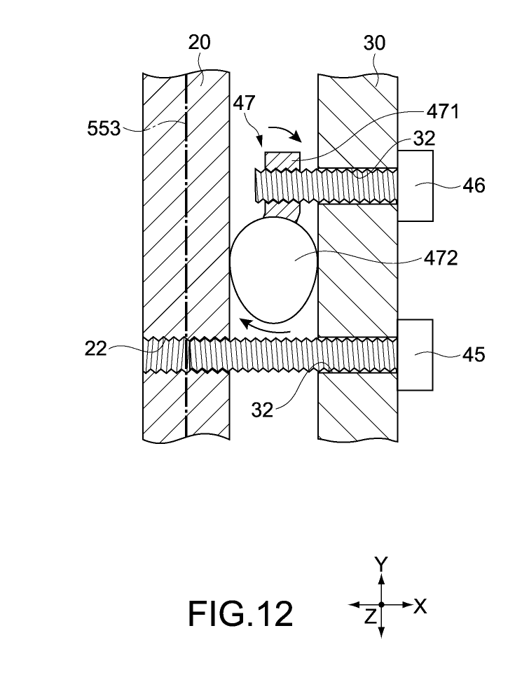

FIG. 12 is a cross-sectional view of an adjustment mechanism of a mask adjustment unit according to a third embodiment of the present technology viewed in the Z-axis direction.

The adjustment mechanism according to this embodiment includes a cam member 47 provided between the movable member 20 and the supporting member 30. The cam member 47 has a connection portion 471 to which a screw portion of a pressing bolt 46 is connected and an operation portion 472 that is brought into contact with the movable member 20 and applies pressing force. The operation portion 472 has an elliptical plate shape or a shape similar thereto, but may have a shape other than those. A screw hole is formed on the connection portion 471, and a screw portion of the pressing bolt 46 is screwed into the screw hole. The pressing bolt 46 is connected to the cam member 47 through the through hole 32 provided on the supporting member 30.

The mechanical relationship between a pulling bolt 45, the supporting member 30, and the movable member 20 is the same as that between the pulling bolt 45, the supporting member 30, and the movable member 20 according to the first embodiment.

When the pressing bolt 46 is tightened, the cam member 47 rotates clockwise in the figure around the connection portion 471 side with the Z-axis direction being a rotation axis. That is, it rotates so that the connection portion 471 side of the cam member 47 approaches the side of the head of the pressing bolt 46 and the operation portion 472 side presses the movable member 20.

As described above, the adjustment mechanism includes the cam member 47 that converts power of the pressing bolt 46 in a moving direction (a first moving direction) along the X-axis direction when the pressing bolt 46 operates into power in a moving direction different from the direction (a second moving direction), i.e., power in a rotation direction here, and transmits it to the movable member 20. In this case, the cam member 47 functions as a conversion member.

Also according to this embodiment, it is possible to generate tension force and pressing force opposite thereto by tightening both bolts in the same tightening direction. Therefore, in the case where an operator manually performs adjustment, the operation can be easily performed. In addition, because the heads of the bolts 45 and 46 are in the state of pressing the supporting member 30, it is possible to suppress the deflection of the bolts 45 and 46 by providing a spring washer, for example, even if disturbance such as vibration and a temperature change is caused.

It should be noted that a conversion member may be connected to the pulling bolt 45, and the conversion unit may pull the movable member 20 from the outer edge portion 553 of the mask main body 55 to an outside direction of the mask main body 55.

### Fourth Embodiment

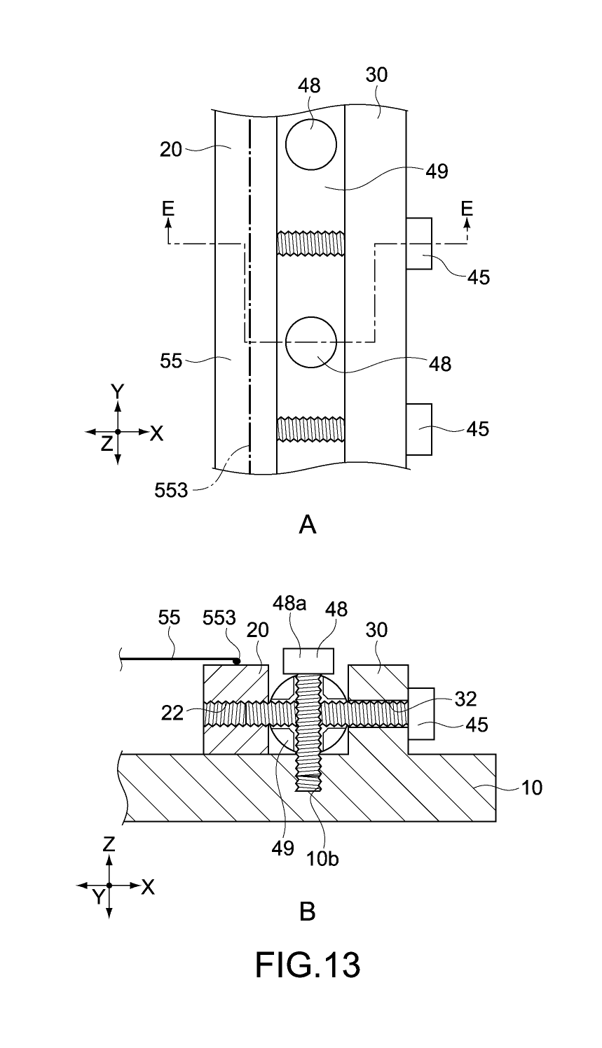

FIG. 13A is a plan view an adjustment mechanism of a mask adjustment unit according to a fourth embodiment of the present technology. FIG. 13B is a cross-sectional view taken along the line E-E in FIG. 13A.

The adjustment mechanism according to this embodiment includes an elastic body 49 as a transmitting member arranged between the supporting member 30 and the movable member 20 provided on the base frame 10. The supporting member 30 functions as a fixed body fixed to the base frame 10. The elastic body 49 is a member having a pipe shape. A pressing bolt 48 is attached to the elastic body 49 and the base frame 10 in the Z-axis direction, and the elastic body 49 and the base frame 10 are connected to each other.

The elastic body 49 is formed to be long in the Y-axis direction, for example. The elastic body 49 may have the similar length to one side length of the mask adjustment unit or the mask main body 55. A plurality of elastic bodies 49 may be provided at a predetermined pitch along one side thereof.

The pulling bolt 45 is screwed into the movable member 20 through the through hole 32 provided on the supporting member 30 and a side through hole provided on the elastic body 49.

By tightening the bolt 48, a head 48a of the bolt 48 approaches the base frame 10. As a result, the elastic body 49 is pressed and is deformed to extend in the X-axis direction. Accordingly, the movable member 20 is pressed inwardly, and stress is inwardly applied to the mask main body 55 from the outer edge portion 553.

According to this embodiment, because the deformation amount due to elastic deformation is small with respect to the moving distance of the bolt 48 in the Z-axis direction, it is possible to fine adjust the position of a mask pattern with high accuracy.

As the elastic body 49, not only a member having a pipe shape, i.e., a hollow member but also solid member may be used. In FIG. 13, the outer shape of the elastic body 49 viewed in the Y-axis direction may be not a circular shape but an elliptical shape or polygon.

Also on the inside of the movable member 20 viewed in the Y-axis direction (the side opposite to the supporting member 30 of outside based on the movable member 20), a supporting member may be provided. Then, the elastic body 49 is arranged between the supporting member 30 and the movable member 20 on the outside, and a second elastic body that is not shown is arranged between the supporting member and the movable member 20 on the inside. The elastic body 49 on the outside is connected to the base frame 10 with the bolt 48. The second elastic body is connected to the base frame 10 with a pulling bolt that is not shown. According to such a configuration of the adjustment mechanism, it is possible to generate both tension force and pressing force using the elastic body 49 and the second elastic body.

Alternatively, no supporting member 30 is provided on the outside of the movable member 20, and an elastic body may be provided between the movable member 20 and a supporting member provided on the inside. In this case, the elastic body generates tension force on the mask main body 55, and the pressing bolt 42 shown in FIG. 6B generates pressing force to the mask main body 55.

### Fifth Embodiment

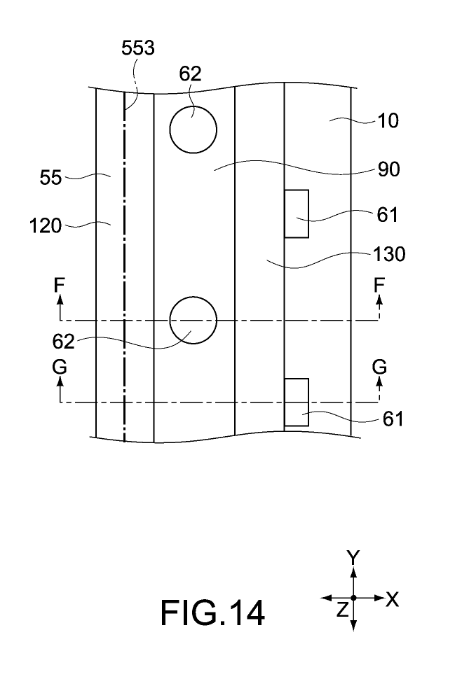

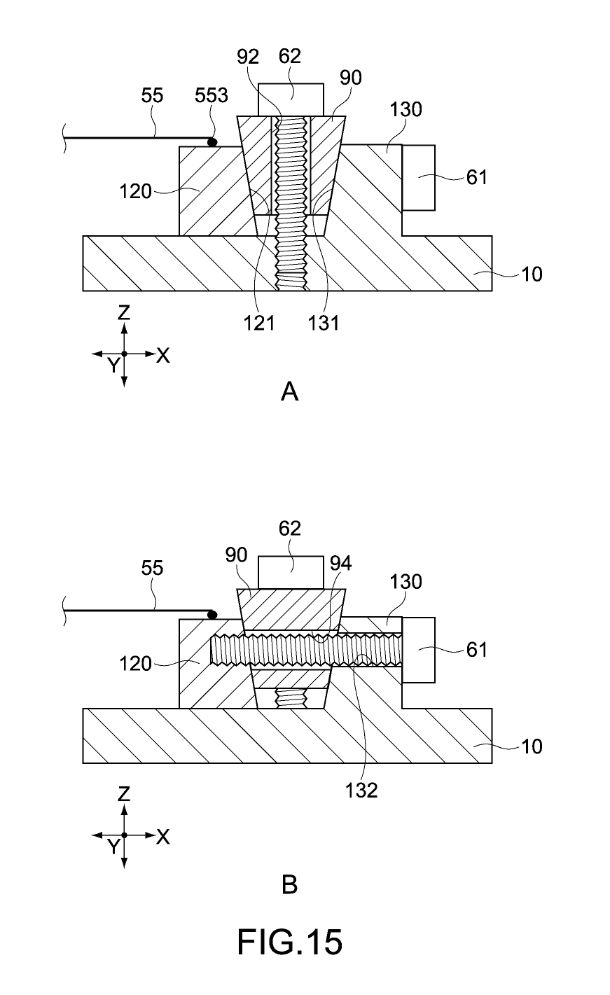

FIG. 14 is a plan view showing an adjustment mechanism of a mask adjustment unit according to a fifth embodiment of the present technology. FIG. 15A is a cross-sectional view taken along the line F-F in FIG. 14. FIG. 15B is a cross-sectional view taken along the line G-G in FIG. 14.

The adjustment mechanism according to this embodiment includes a fixed body 130 provided on the base frame 10, a movable member 120 that faces the fixed body 130, a block member 90 as a transmitting member provided between the fixed body 130 and the movable member 120, a pressing bolt 62, and a pulling bolt 61.

The fixed body 130 has a tapered surface 131 that faces the movable member 120. Also the movable member 120 has a tapered surface 121 that faces the tapered surface 131 of the fixed body 130. The movable member 120 and the fixed body 130 are formed so that the interval between the tapered surfaces 121 and 131 is changed toward the Z-axis direction, i.e., expands toward the upper side of the vertical direction, here. The block member 90 is arranged between the tapered surfaces 121 and 131 so that the block member 90 is in contact with the tapered surfaces 121 and 131. Specifically, also both side surfaces of the block member 90 are tapered surfaces.

As shown in FIG. 15A, the pressing bolt 62 is connected to the base frame 10 through a vertical through hole 92 provided on the block member 90 from the upper surface side of the block member 90, for example. As shown in FIG. 15B, the pulling bolt 61 is connected to the movable member 120 through a through hole 132 and a vertical through hole 94 provided on the block member 90 from the outside surface of the fixed body 130.

The inner diameter of the vertical through hole 92 and the through hole 94 is formed to be sufficiently larger than the diameter of the screw portion of the pressing bolt 62 and the pulling bolt 61. The inner diameter is designed taking into account the range in which the block member 90 is moved in horizontal and vertical directions by the tightening action of the bolts 61 and 62.

For example, by tightening the pressing bolt 62, the block member 90 is moved downward along the Z-axis direction. Accordingly, the movable member 120 is separated from the fixed body 130, and inward pressing force is applied to the mask main body 55.

The tapered surfaces 121 and 131 of the movable member 120 and the fixed body 130 may be not a flat surface but a curved surface.

It should be noted that in FIG. 15B, by making the shown angle of the tapered surface close to horizontal, it is possible to reduce the force tightening the pulling bolt 61 for applying tension to the mask main body 55.

In this embodiment, it does not necessarily need to provide the pressing bolt 62 and the pulling bolt 61. In this case, it only needs to move the block member 90 vertically and horizontally with a jig that is not shown. In order to move the block member 90 in the upper direction, the jig needs to press the block member through an operation opening (not shown) provided on the base frame 10 as shown in FIG. 15B, for example.

### Sixth Embodiment

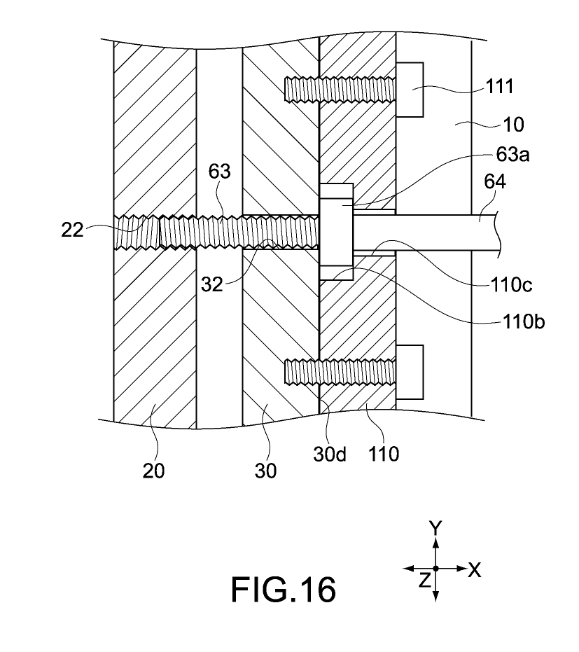

FIG. 16 is a cross-sectional view of an adjustment mechanism of a mask adjustment unit according to a sixth embodiment of the present technology viewed in the Z-axis direction.

The adjustment mechanism according to this embodiment includes a bolt 63 for performing pressing and pulling and a regulation member (regulation portion) 110 that regulates the movement of the bolt 63 with respect to the supporting member 30 along the direction of mounting and removing the bolt 63, i.e., X-axis direction. The regulation member 110 is fixed to a side surface 30d of the supporting member 30 with another bolt 111 or the like.

The bolt 63 is screwed into the movable member 20 through the through hole 32 of the supporting member 30 in the state where a head 63a is brought into contact with the side surface 30d of the supporting member 30. The regulation member 110 has a space 110b that covers the head 63a of the bolt 63, and the space 110b is communicated with the outside of the regulation member 110 through an operating hole 110c. An operating member 64 such as a wrench is inserted into the operating hole 110c, and the operating member 64 can be connected to the head 63a of the bolt 63.

By tightening the bolt 63 through the operating member 64, the movable member 20 approaches the supporting member 30, thereby generating tension force on the mask main body. By loosening the bolt 63 through the operating member 64, the movable member 20 is separated from the supporting member 30, and the tension force on the mask main body is weakened.

As described above, in this embodiment, it is possible to perform pressing and pulling with one bolt 63.

### Seventh Embodiment

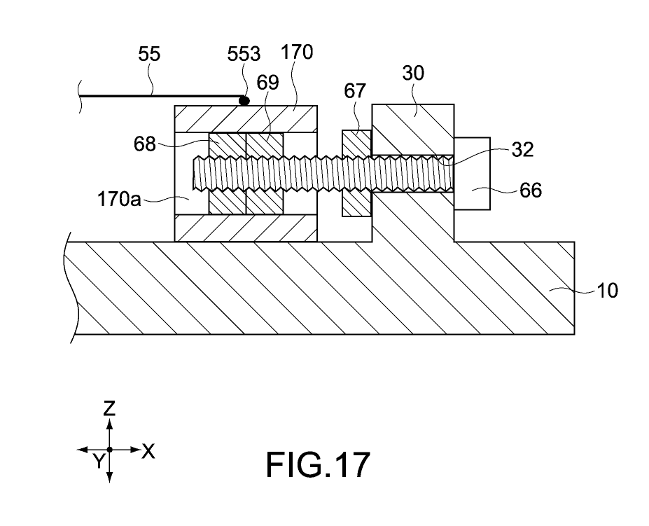

FIG. 17 is a cross-sectional view of an adjustment mechanism of a mask adjustment unit according to a seventh embodiment of the present technology viewed in the Y-axis direction.

The adjustment mechanism according to this embodiment includes a bolt 66 for performing pressing and pulling and a color 67 as a regulation portion that regulates the movement of the bolt 66 with respect to the supporting member 30 in the X-axis direction. The bolt 66 is inserted into the through hole 32 of the supporting member 30. A head 66a of the bolt 66 is brought into contact with the outside surface of the supporting member 30, and the color 67 is screwed into the bolt 66, is brought into contact with the inside surface of the supporting member 30, and is fixed.

Moreover, the adjustment mechanism includes two nuts 68 and 69 fixed in a vertical hole 170a of a movable member 170, and the bolt 66 is screwed into the nuts 68 and 69. The nuts 68 and 69 can prevent displacement and backlash due to external force from occurring.

### Eighth Embodiment

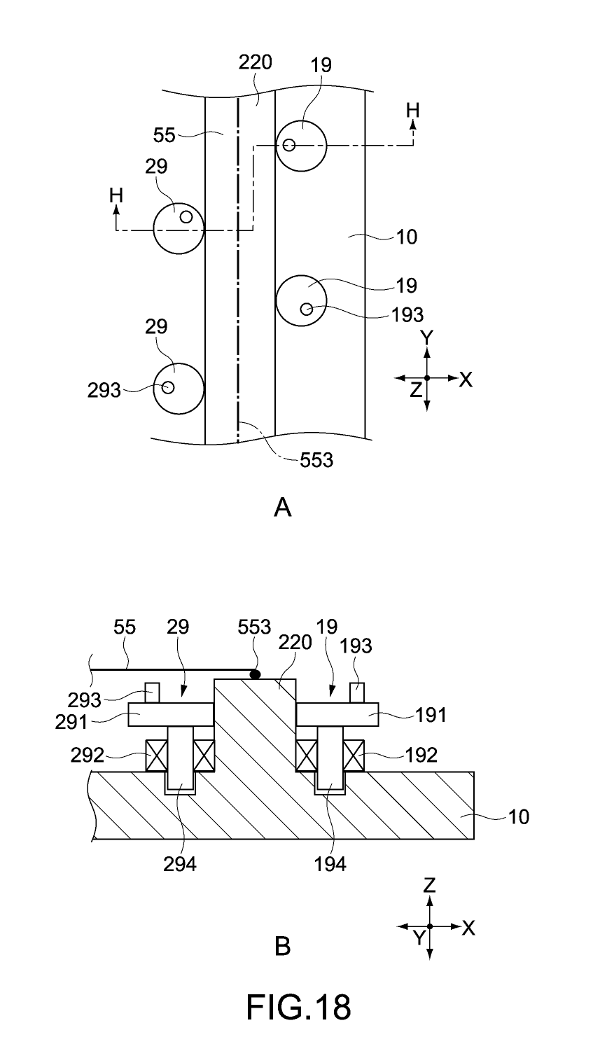

FIG. 18A is a plan view showing an adjustment mechanism of a mask adjustment unit according to an eighth embodiment of the present technology. FIG. 18B is a cross-sectional view taken along the line H-H in FIG. 18A.

The adjustment mechanism according to this embodiment includes cam members 19 and 29 (first cam member and second cam member) provided on the inside and outside of a movable member 220. The cam member 19 (29) includes a cam head 191 (291) that is brought into contact with both side surfaces of the movable member 220 and an eccentric axis 194 (294) that is eccentrically provided on the cam head 191 (291). The eccentric axis 194 (294) is rotatably connected to the base frame 10 with a bearing 192 (292).

The cam member 19 for pressing is arranged on the outside of the movable member 220, and the cam member 29 for pulling is arranged on the inside of the movable member 220. In addition, the cam member 19 for pressing and the cam member 29 for pulling are arranged alternately in the Y-axis direction, for example.

On the upper surface of the cam head 191 (291), a handle 193 (293) for operation is provided. The cam member 19 (29) rotates via the handle 193 (293) with the eccentric axis 194 (294) being a rotational axis. Accordingly, it is possible to apply tension force and pressing force to the mask main body 55 fixed to the movable member 220.

Also to the mask adjustment units according to the third to eighth embodiments described above, any one of the above-mentioned position holding mechanisms (see FIGS. 9A to C) may be applied.

### Ninth Embodiment

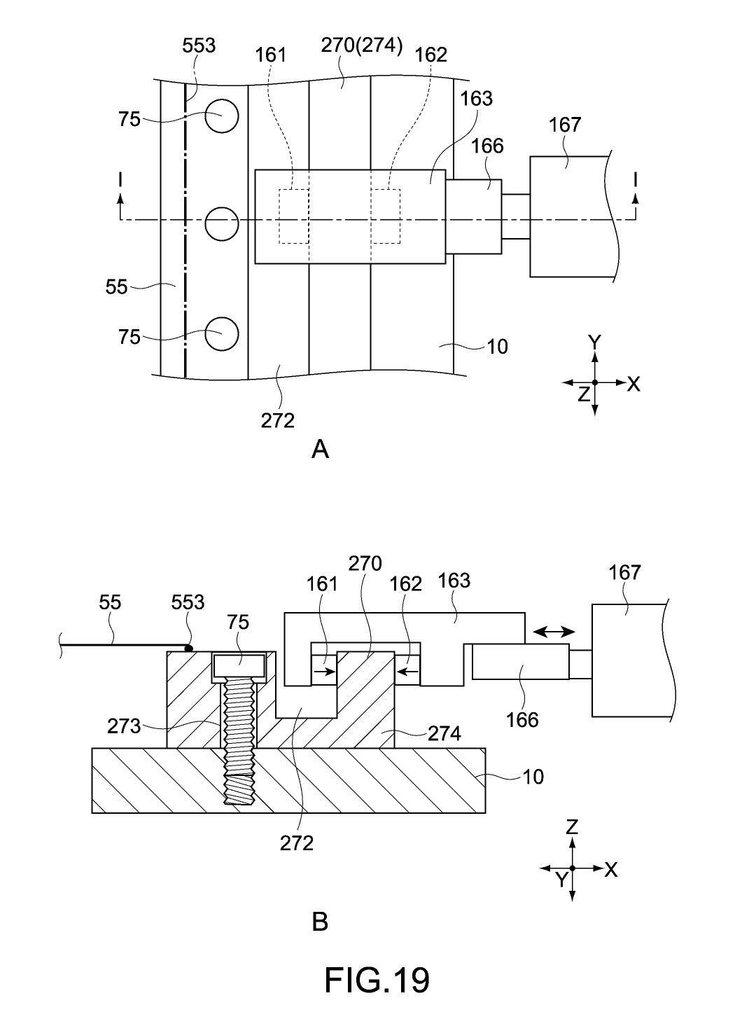

FIG. 19A is a plan view showing an adjustment mechanism of a mask adjustment unit according to a ninth embodiment of the present technology. FIG. 19B is a cross-sectional view taken along the line I-I in FIG. 19A.

A movable member 270 of the adjustment mechanism according to this embodiment includes a trench 272 along the Y-axis direction. Piezoelectric elements 161 and 162 are connected to both inside surface and outside surface of a wall portion 274 formed by the trench 272.

The piezoelectric element 162 that presses the outside surface of the wall portion 274 applies inward pressing force to the mask main body 55. The piezoelectric element 161 that presses the inside surface of the wall portion 274 applies outward tension force to the mask main body 55.

In this embodiment, a holder 163 that holds each of the piezoelectric elements 161 and 162 is provided. The holder 163 is connected to a stage 166 that is movable in the X-axis direction, for example. The stage 166 is driven by a driving mechanism 167 using a stepping motor or the like as a driving source. With the driving of the stage 166, it is possible to coarse adjust the position of the mask pattern of the mask main body 55 via the holder 163 and the movable member 270.

The stage 166 for coarse adjustment and the driving mechanism 167 do not necessarily need to be provided.

It should be noted that on the movable member 270 and the base frame 10, a screw hole 273 to which the fixing bolt 75 is attached as a mechanism for holding the position of the mask main body 55 after adjustment (position holding mechanism) is formed.

### [Embodiment of Mask Producing Apparatus]

An operator may manually adjust the position of a mask pattern using the mask adjustment unit according to each embodiment, and a mask producing apparatus may automatically adjust the position as will be described later.

### [Example 1 of Mask Producing Apparatus]

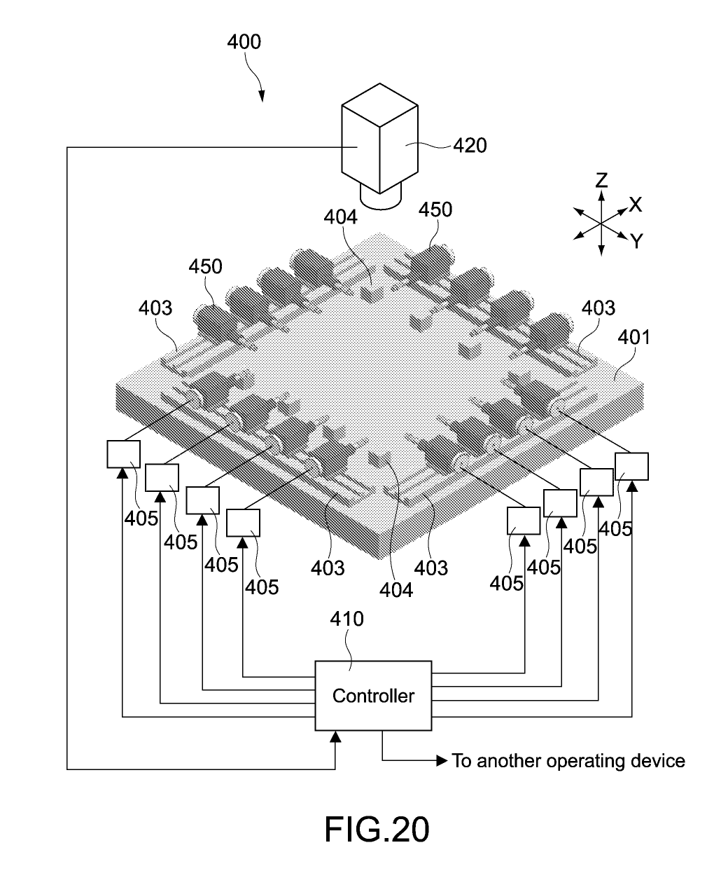

FIG. 20 is a diagram showing a mask producing apparatus according to an embodiment. In this embodiment, an example in which the mask device 100 according to the first embodiment is adjusted (produced) will be described.

A mask producing apparatus 400 includes a supporting base 401, a base frame supporting portion 404 provided on the supporting base 401, and an operating device 450 that is provided on the outside of the base frame supporting portion 404 and operates the adjustment mechanism 40. In addition, the mask producing apparatus 400 includes a motor driver 405 that drives the operating device 450, a camera 420 provided on the upper portion, and a controller 410.

A plurality of operating devices 450 are arranged along the direction of four sides of the supporting base 401 having a rectangular shape. Moreover, on the supporting base 401, a guide mechanism 403 that allows the position of the operating device 450 to be changed is provided. The guide mechanism 403 includes a guide rail. The guide rail allows the position of the operating device 450 to be changed along each side, and the operating device 450 can be fixed at a predetermined position with a bolt or the like.

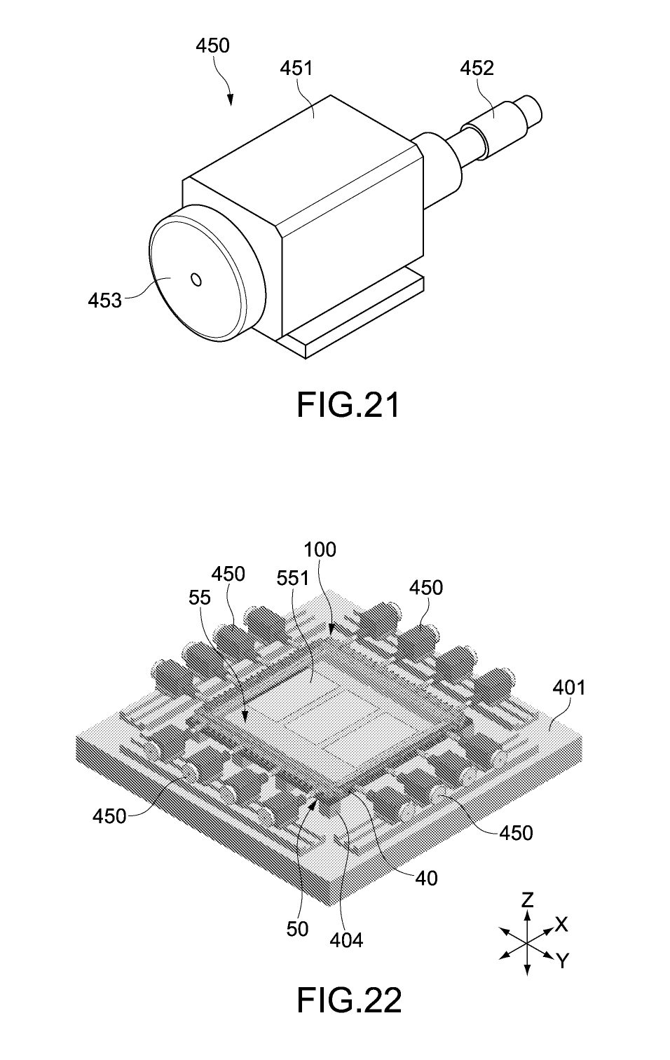

FIG. 21 is a perspective view showing one operating device 450. The operating device 450 includes a motor 451 provided with a reducer (e.g., reducing gear), and a wrench adaptor 452 attached to an output axis of the motor 451. The end portion of the wrench adopter 452 can be connected to the pulling bolt 41 and the pressing bolt 42 of the adjustment mechanism 40, as shown in FIG. 22, for example. For example, a concave portion that is not shown is provided on the end portion of the wrench adopter 452, and the heads 41a and 42a of the pulling bolt 41 and the pressing bolt 42 (see FIGs. 6A and B) fit into the concave portion of the end portion of the wrench adopter 452. Thus, the operating device 450 is connected to the adjustment mechanism 40 (See FIG. 1).

As the motor 451, a stepping motor or a servomotor is used, for example. A reducing gear is often mounted on a commonly-used stepping motor.

The reduction ratio by a reducer is set to, for example, about 1/60 to 1/40, typically, 1/50. In the case where an M3 bolt is used for the operating device 450 with a reduction ratio of 1/50, it is possible to achieve a driving amount of 10 μm/revolution. Accordingly, it is possible to easily perform a positional adjustment of μm order.

It should be noted that the motor 451 is provided with also a handle 453. An operator can manually rotate the handle 453, and thus, the operating device 450 drives the adjustment mechanism 40.

The camera 420 detects the location information (actual location information) of a mask pattern by taking an image of the pattern surface 551 of the mask main body 55 particularly, of the mask device 100 supported by the supporting base 401 (see FIG. 22). The camera 420 may move in the X or Y axis.

The controller 410 stores at least designing location information being location information of a mask pattern of designing information of the mask main body 55 stored in advance, for example. Moreover, the controller 410 acquires the actual location information of a mask pattern detected by the camera 420, and performs predetermined calculation to be described later based on the actual location information and the above-mentioned designing location information.

The controller 410 may typically include a computer such as CPU, RAM, and ROM. The designing location information of a mask pattern may be stored in another storage device connected to the controller 410 by wire or wireless.

At least one operating device 450 may be provided on only one side of the supporting base 401, for example, and may be provided on each of at least two sides. The number and arrangement of the operating device 450 can be appropriately set depending on the shape of a mask pattern or a position in the pattern surface 551 to be corrected.

The operation of the mask producing apparatus 400 will be described.

First, as shown in FIG. 22, an operator places the mask device 100 shown in FIGS. 1 and 2, for example, on the base frame supporting portion 404, and fixes it with a fixture or the like that is not shown. Then, the operator sets the position of each operating device 450 on the guide mechanism 403, and positions each operating device 450. In addition, the operator connects the wrench adopter 452 of the operating device 450 to the pulling bolt 41 and the pressing bolt 42 of the adjustment mechanism 40.

As the mask device 100 placed on the mask producing apparatus 400, the mask main body 55 bonded to the mask adjustment unit 50 by welding is used. In addition, the mask device 100 that is used by a deposition apparatus actually before being applied with a washing process may be used.

The controller 410 acquires the actual location information of a mask pattern by taking an image of the entire pattern surface 551 of the mask main body 55 with the camera 420. The actual location information is information obtained by binarizing information of the taken image of the mask pattern by an image process.

The controller 410 acquires the designing location information of the mask main body 55 from a memory, and calculates the displacement amount of the actual location information from the designing location information based on the acquired designing information and the obtained actual location information that is detected by the camera 420. For example, the controller 410 calculates the displacement amount by calculating the difference between information on coordinate of a passing hole as the designing location information and information on actual coordinate of the passing hole as the actual location information.

The controller 410 transmits, to the motor driver 405, a control signal that corrects the calculated displacement amount, i.e., control signal for making the calculated displacement amount close to zero. The motor driver 405 drives the operating device 450 based on the control signal. Accordingly, it is possible to automatically make the position of a mask pattern close to the position on designing.

The controller 410 may store the correlation between the displacement amount and a value of a drive signal by the motor driver 405 in a memory or the like using a look-up table. The look-up table may be stored for each mask pattern, and for each material of the mask main body 55.

Examples of a method of creating a look-up table include the following method. A torque is generated by the operating device 450, and the transmission of the torque to the pulling bolt 41 and the pressing bolt 42 is started. The positions of the movable member 20 (see, for example, FIG. 1) and a mask pattern are not moved until rattling of rotation by the operating device 450 is eliminated. In this case, the controller 410 or the operating device 450 only needs to have a function to detect the torque. This is because it is possible to detect the point where the rattling is eliminated with a torque value, and to set the point to a zero point (reference point) at the time of adjustment. With this function, it is possible to achieve the correlation between the displacement amount and a drive signal to be output.

Alternatively, the controller 410 may use a predetermined algorithm to calculate a value of a control signal to be output, based on the calculated displacement amount.

In the case where the mask device 100 includes the above-mentioned position holding mechanism (see, for example, FIGS. 9A to C), an operator holds the position of a mask pattern after adjustment by the position holding mechanism after the automatic positional adjustment is performed by the mask producing apparatus 400 as described above.

According to the mask producing apparatus 400 according to this embodiment, it is possible to automatically adjust the position of a mask pattern of the mask main body 55, appropriately. Therefore, it is possible to increase the productivity of a display device produced by the mask device 100.

### (Example 2 of a Mask Producing Apparatus)

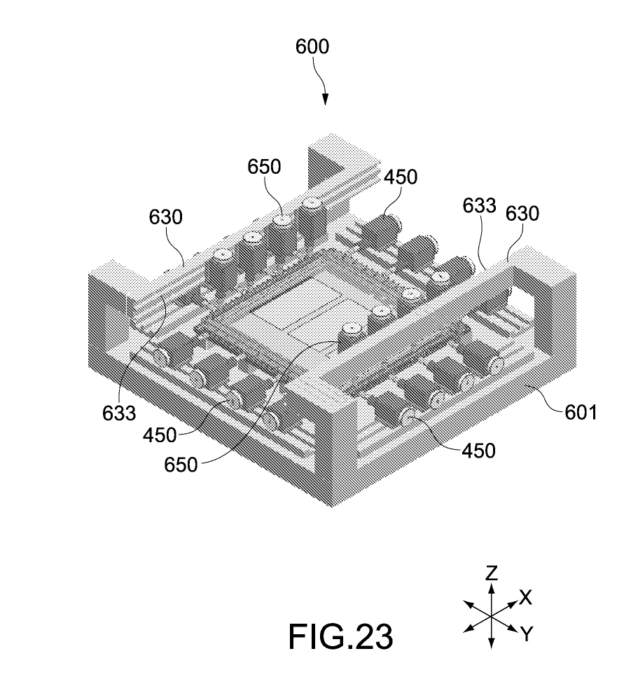

FIG. 23 is a perspective view showing a mask producing apparatus according to another example. The difference between a mask producing apparatus 600 and the mask producing apparatus 400 shown in FIG. 20 is that the mask producing apparatus 600 includes a Z operating device 650. The Z operating device 650 operates the Z adjustment bolt 31 (see FIG. 7) by the Z adjustment mechanism 45 of the mask device 100. The Z operating device 650 includes the similar mechanism (motor 451 with a reducer) to the above-mentioned operating device 450.

A plurality of Z operating devices 650 are provided. The plurality of Z operating devices 650 are slidably and fixably connected to (e.g., two) beams provided on the supporting base 401 along the X-axis direction, for example, by the above-mentioned guide mechanism 403.

Moreover, a dial gage that is not shown is attached to each beam. The dial gage measures the deflection amount by measuring height positions of two sides of the base frame 10 of the mask device 100 in the X-axis direction. The device that measures the deflection amount is not limited to a dial gage, and a photosensor may be used, for example.

For example, the controller 410 can calculate the deflection amount by storing the distance between the dial gage to a side of the base frame 10 in advance when the side of the base frame 10 along the X-axis direction is in a horizontal state and comparing the stored information with the distance actually measured.

It should be noted that on the supporting bases 401 and 601, no member that supports two sides of the base frame 10 in the X-axis direction is provided. Therefore, when the base frame 10 is supported on the supporting bases 401 and 601, deflection is caused by the weight of the mask device 100. That is, as shown in FIG. 20, the base frame supporting portion 404 of the supporting base 401 is provided only along the Y-axis direction. That is, the mask producing apparatuses 400 and 600 are each an apparatus assuming that a conveyor supports only a side of the base frame 10 along the Y-axis direction in the above-mentioned deposition apparatus.

The controller 410 (see FIG. 20) acquires the deflection amount detected by the dial gage. Then, the controller 410 transmits a control signal to a motor driver that drives the Z operating device 650, which is not shown, so that the deflection amount is corrected (the deflection amount is made to be close to zero). The motor driver drives the Z operating device 650 according to the control signal, and tightens the Z adjustment bolt 31.

The controller 410 only needs to store the correspondence between the deflection amount and a value of a control signal to be output in a memory or the like using a look-up table. The look-up table may be stored for each mask pattern, and for each material of the mask main body 55.

Alternatively, the controller 410 may calculate the value of a control signal to be output using a predetermined algorithm based on the calculated deflection amount.

The method of adjusting tension force and pressing force by the mask producing apparatus 600 is the same as the method by the mask producing apparatus 600.

According to the mask producing apparatus 600 according to this embodiment, it is possible to automatically adjust not only the position of a mask pattern of the mask main body 55 but also deflection of the base frame 10 of the mask device 100.

As another example of the mask producing apparatuses 400 and 600, in the case where the mask adjustment unit 50 includes the piezoelectric element 60 (see, for example, FIG. 10), there is no need of the operating device 450 and a wiring connected to the piezoelectric element 60 is provided. Accordingly, it is possible to achieve the miniaturization and simplification of the mask producing apparatuses 400 and 600.

### Other Embodiments

The present technology is not limited to the above-mentioned embodiments, and can achieve other various embodiments.

The mask according to the present technology is used in a process of producing a display device using an organic EL device, and an example in which the mask is used in a process of depositing an organic material has been described. However, the mask according to the present technology may be applied to a deposition process of not only an organic material but also a meal material, a dielectric material, or the like. Alternatively, the mask may be used as not only a mask for deposition but also a mask for exposure, a mask for printing, or the like.

Moreover, the display device is not limited to an organic EL device, and may be a liquid crystal display device. The device being a producing target by a mask is not limited to a display device.

In the first embodiment, one pulling bolt 41 and one pressing bolt 42 are alternately arranged. However, a plurality of pulling bolts may be continuously arranged, or a plurality of pressing bolts 42 may be continuously arranged.

In the first embodiment, four movable members 20 are provided corresponding to the four sides of the base frame 10 having a rectangular frame shape. However, at least one movable member 20 may be provided corresponding to at least one side. For example, two movable members 20 may be provided on two opposing sides. The same shall apply to the second to ninth embodiments.

In the above-mentioned embodiments, as shown in FIG. 7, the tapered surface 301b has been provided on the lower surface of the supporting member 301 that functions as an adjustment frame. However, the lower surface of the supporting member 301 may be a flat surface, and such a concave surface may be formed on a surface of the base frame 10, which faces the supporting member 301, i.e., the upper surface of the base frame 10. Alternatively, a concave surface may be provided on the supporting member 30 and the base frame 10.

For example, as shown in FIGS. 1 and 2, the pulling bolt 41 and the pressing bolt 42 have been provided on the supporting member 301 along the X-axis direction. However, it does not necessarily need to provide the pulling bolt 41 and the pressing bolt 42 on the supporting member 301, and only equipment for adjusting the Z-axis may be provided.

Alternatively, in addition to the supporting member 301, an adjustment frame for adjusting the Z-axis may be separately provided on the base frame 10. Moreover, the adjustment frame for adjusting the Z-axis may be provided on all four sides of the base frame 10.

In the above-mentioned embodiments, a bolt (fixing bolt) is used as a main element of a position holding mechanism. In addition to the bolt, a clamping mechanism, a piezoelectric element, or another mechanism may be used.

The arrangement of the base frame supporting portion 404 provided on the supporting base 401 of the mask producing apparatus 400 according to each embodiment can be changed appropriately depending on designing of a processing apparatus (e.g., the above-mentioned deposition apparatus) that processes a substrate using the mask device 100. The same shall apply also to the mask producing apparatus 600.

The above-mentioned mask producing apparatus may be mounted on a deposition apparatus, or connected to a deposition apparatus in line. Accordingly, a process for producing a mask device by a mask producing apparatus and a deposition process by a deposition apparatus are automatically performed. Accordingly, it is possible to perform these processes without manual operation. In this case, a process for producing a mask device may be performed under vacuum.

At least two feature portions of the embodiments described above can be combined.

It should be noted that the present technology may also take the following structures.

(1) A mask adjustment unit, including:

a base body;

a movable member that supports a side of an outer edge portion of a mask main body and is movably provided on the base body, the mask main body having the outer edge portion; and

an adjustment mechanism that applies, to the mask body via the movable member, both pulling tension force from the outer edge portion of the mask main body to outside of the mask main body and pressing force pressing from the outer edge portion to inside of the mask main body, the mask body being supported by the movable member.

(2) The mask adjustment unit according to (1), in which

the adjustment mechanism includes at least one bolt that acts on the movable member.

(3) The mask adjustment unit according to (2), in which

the adjustment mechanism includes
a first bolt that applies the tension force to the mask main body, and
a second bolt that applies the pressing force to the mask main body.
   (4) The mask adjustment unit according to (3), in which

the adjustment mechanism has a supporting portion that supports the first bolt and the second bolt, the supporting portion being provided on the base body, and

the movable member has a screw hole into which the first bolt is inserted and a contact area with which an end portion of the second bolt is brought into contact.

(5) The mask adjustment unit according to (3), in which

the adjustment mechanism further includes a conversion member that is connected to at least one of the first bolt and the second bolt, converts power of the at least one bolt in a first moving direction into power in a second moving direction, and transmits the converted power to the movable member, the second moving direction being different from the first moving direction.

(6) The mask adjustment unit according to (3), in which

the adjustment mechanism further includes
a fixed body provided on the base body, and
a transmitting member that is connected to the base body with any one of the first bolt and the second bolt between the fixed body and the movable member, converts power of any one of the first bolt and the second bolt in a first moving direction into power in a second moving direction, and transmits the converted power to the movable member, the second moving direction being different from the first moving direction.
   (7) The mask adjustment unit according to claim 6), in which

the transmitting member is an elastic body that acts on the movable member by an elastic deformation.

(8) The mask adjustment unit according to (6), in which

the movable member has a tapered surface,

the fixed body has a tapered surface facing the tapered surface of the movable member and is provided on the base body so that interval between the tapered surface of the movable member and the tapered surface of the fixed body changes toward a vertical direction of a pattern surface on which a mask pattern is formed, the mask main body having the pattern surface, and

the transmitting member is a block member arranged between the tapered surface of the movable member and the tapered surface of the fixed body so that the block member is brought into contact with the tapered surfaces.

(9) The mask adjustment unit according to (2), in which

the adjustment mechanism further has
a supporting portion provided on the base body, which supports the bolt, and
a regulation portion that regulates movement of the bolt along an inserting and removing direction of the bolt with respect to the supporting portion.
   (10) The mask adjustment unit according to (1), in which

the adjustment mechanism includes
a first cam member that applies the tension force to the mask main body, and
a second cam member that applies the pressing force to the mask main body.
   (11) The mask adjustment unit according to (1), in which

the adjustment mechanism includes a piezoelectric element capable of applying the tension force and the pressing force to the mask main body.

(12) The mask adjustment unit according to any one of (1) to (11), further including:

an adjustment frame connected to the base body so that the adjustment frame faces the base body in a direction vertical to a pattern surface on which a mask pattern is formed and a gap is formed between the adjustment frame and the base body, the mask main body having the pattern surface; and

an adjustment member that adjusts a distance of the gap in the vertical direction.

(13) A mask device, including:

a mask main body having an outer edge portion;

a base body;

a movable member that supports a side of the outer edge portion of the mask main body and is movably provided on the base body; and

an adjustment mechanism that applies, to the mask body via the movable member, both pulling tension force from the outer edge portion of the mask main body to outside of the mask main body and pressing force pressing from the outer edge portion to inside of the mask main body, the mask body being supported by the movable member.

(14) A mask producing apparatus for producing a mask device by adjusting a position of a mask pattern of a mask main body having an outer edge portion, a pattern surface, and the mask pattern formed on the pattern surface, the mask producing apparatus including:

a detection unit that detects actual location information being location information on the mask pattern in the pattern surface in a state where the mask main body of the mask device is supported by a movable member, the mask device including
the mask main body,
a base body,
the movable member that supports a side of the outer edge portion of the mask main body and is movably provided on the base body, and
an adjustment mechanism that applies, to the mask body via the movable member, both pulling tension force from the outer edge portion of the mask main body to outside of the mask main body and pressing force pressing from the outer edge portion to inside of the mask main body, the mask body being supported by the movable member;

an operating device that drives the adjustment mechanism of the mask device; and

a controller that acquires designing location information being location information of the mask pattern out of designing information of the mask main body, calculates an amount of displacement of the actual location information from the designing location information based on the acquired designing location information and the detected actual location information, and controls the operating device based on the calculated displacement amount.

(15) The mask producing apparatus according to (14), in which

the operating device includes
a motor, and
a reducer that reduces drive of the motor.
   (16) The mask producing apparatus according to (14) or (15), further including

a guide mechanism that allows the operating device to move along the mask main body.

(17) A mask producing method for producing a mask device by adjusting a position of a mask pattern of a mask main body having an outer edge portion, a pattern surface, and the mask pattern formed on the pattern surface, the mask producing method including:

detecting actual location information being location information of the mask pattern in the pattern surface in a state where the mask main body of the mask device is supported by a movable member, the mask device including
the mask main body,
a base body,
the movable member that supports a side of the outer edge portion of the mask main body and is movably provided on the base body, and
an adjustment mechanism that applies, to the mask body via the movable member, both pulling tension force from the outer edge portion of the mask main body to outside of the mask main body and pressing force pressing from the outer edge portion to inside of the mask main body, the mask body being supported by the movable member;

acquiring designing location information being location information of the mask pattern out of designing information of the mask main body;

calculating an amount of displacement of the actual location information from the designing location information based on the acquired designing location information and the detected actual location information; and

controlling an operating device that drives the adjustment mechanism of the mask based on the calculated displacement amount.

### DESCRIPTION OF REFERENCE SYMBOLS

10 base frame
19, 29 cam member
20, 70, 120, 170, 220, 270 movable member
21 fixing bolt
24a contact area
30, 80, 301 supporting member
40 adjustment mechanism
41, 61 pulling bolt
42, 62 pressing bolt
45 Z adjustment mechanism
46, 48, 63, 66 bolt
49 elastic body
50 mask adjustment unit
55 mask main body
60, 161, 162 piezoelectric element
90 block member
100 mask device
110 regulation member
121, 131 tapered surface
130 fixed body
301 supporting member
400, 600 mask producing apparatus
403 guide mechanism
410 controller
420 camera
450 operating device
551 pattern surface
553 outer edge portion

1. A mask adjustment unit, comprising:
a base body;
a movable member that supports a side of an outer edge portion of a mask main body and is movably provided on the base body, the mask main body having the outer edge portion; and
an adjustment mechanism that applies, to the mask body via the movable member, both pulling tension force from the outer edge portion of the mask main body to outside of the mask main body and pressing force pressing from the outer edge portion to inside of the mask main body, the mask body being supported by the movable member.

2. The mask adjustment unit according to claim 1, wherein
the adjustment mechanism includes at least one bolt that acts on the movable member.

3. The mask adjustment unit according to claim 2, wherein
the adjustment mechanism includes
a first bolt that applies the tension force to the mask main body, and
a second bolt that applies the pressing force to the mask main body.

4. The mask adjustment unit according to claim 3, wherein
the adjustment mechanism has a supporting portion that supports the first bolt and the second bolt, the supporting portion being provided on the base body, and
the movable member has a screw hole into which the first bolt is inserted and a contact area with which an end portion of the second bolt is brought into contact.

5. The mask adjustment unit according to claim 3, wherein
the adjustment mechanism further includes a conversion member that is connected to at least one of the first bolt and the second bolt, converts power of the at least one bolt in a first moving direction into power in a second moving direction, and transmits the converted power to the movable member, the second moving direction being different from the first moving direction.

6. The mask adjustment unit according to claim 3, wherein
the adjustment mechanism further includes
a fixed body provided on the base body, and
a transmitting member that is connected to the base body with any one of the first bolt and the second bolt between the fixed body and the movable member, converts power of any one of the first bolt and the second bolt in a first moving direction into power in a second moving direction, and transmits the converted power to the movable member, the second moving direction being different from the first moving direction.

7. The mask adjustment unit according to claim 6, wherein
the transmitting member is an elastic body that acts on the movable member by an elastic deformation.

8. The mask adjustment unit according to claim 6, wherein
the movable member has a tapered surface,
the fixed body has a tapered surface facing the tapered surface of the movable member and is provided on the base body so that interval between the tapered surface of the movable member and the tapered surface of the fixed body changes toward a vertical direction of a pattern surface on which a mask pattern is formed, the mask main body having the pattern surface, and
the transmitting member is a block member arranged between the tapered surface of the movable member and the tapered surface of the fixed body so that the block member is brought into contact with the tapered surfaces.

9. The mask adjustment unit according to claim 2, wherein
the adjustment mechanism further has
a supporting portion provided on the base body, which supports the bolt, and
a regulation portion that regulates movement of the bolt along an inserting and removing direction of the bolt with respect to the supporting portion.

10. The mask adjustment unit according to claim 1, wherein
the adjustment mechanism includes
a first cam member that applies the tension force to the mask main body, and
a second cam member that applies the pressing force to the mask main body.

11. The mask adjustment unit according to claim 1, wherein
the adjustment mechanism includes a piezoelectric element capable of applying the tension force and the pressing force to the mask main body.

12. The mask adjustment unit according to claim 1, further comprising:
an adjustment frame connected to the base body so that the adjustment frame faces the base body in a direction vertical to a pattern surface on which a mask pattern is formed and a gap is formed between the adjustment frame and the base body, the mask main body having the pattern surface; and
an adjustment member that adjusts a distance of the gap in the vertical direction.

13. A mask device, comprising:
a mask main body having an outer edge portion;
a base body;
a movable member that supports a side of the outer edge portion of the mask main body and is movably provided on the base body; and
an adjustment mechanism that applies, to the mask body via the movable member, both pulling tension force from the outer edge portion of the mask main body to outside of the mask main body and pressing force pressing from the outer edge portion to inside of the mask main body, the mask body being supported by the movable member.

14. A mask producing apparatus for producing a mask device by adjusting a position of a mask pattern of a mask main body having an outer edge portion, a pattern surface, and the mask pattern formed on the pattern surface, the mask producing apparatus comprising:
a detection unit that detects actual location information being location information on the mask pattern in the pattern surface in a state where the mask main body of the mask device is supported by a movable member, the mask device including
the mask main body,
a base body,
the movable member that supports a side of the outer edge portion of the mask main body and is movably provided on the base body, and
an adjustment mechanism that applies, to the mask body via the movable member, both pulling tension force from the outer edge portion of the mask main body to outside of the mask main body and pressing force pressing from the outer edge portion to inside of the mask main body, the mask body being supported by the movable member;
an operating device that drives the adjustment mechanism of the mask device; and
a controller that acquires designing location information being location information of the mask pattern out of designing information of the mask main body, calculates an amount of displacement of the actual location information from the designing location information based on the acquired designing location information and the detected actual location information, and controls the operating device based on the calculated displacement amount.

15. The mask producing apparatus according to claim 14, wherein
the operating device includes
a motor, and
a reducer that reduces drive of the motor.

16. The mask producing apparatus according to claim 14, further comprising
a guide mechanism that allows the operating device to move along the mask main body.

17. A mask producing method for producing a mask device by adjusting a position of a mask pattern of a mask main body having an outer edge portion, a pattern surface, and the mask pattern formed on the pattern surface, the mask producing method comprising:
detecting actual location information being location information of the mask pattern in the pattern surface in a state where the mask main body of the mask device is supported by a movable member, the mask device including
the mask main body,
a base body,
the movable member that supports a side of the outer edge portion of the mask main body and is movably provided on the base body, and
an adjustment mechanism that applies, to the mask body via the movable member, both pulling tension force from the outer edge portion of the mask main body to outside of the mask main body and pressing force pressing from the outer edge portion to inside of the mask main body, the mask body being supported by the movable member;
acquiring designing location information being location information of the mask pattern out of designing information of the mask main body;
calculating an amount of displacement of the actual location information from the designing location information based on the acquired designing location information and the detected actual location information; and
controlling an operating device that drives the adjustment mechanism of the mask based on the calculated displacement amount.
